(19) United States
(12) Patent Application Publication
(10) Pub. No.: US 2024/0023553 A1
(43) Pub. Date: Jan. 25, 2024

(54) PESTICIDAL COMPOSITION

(71) Applicant: SUMITOMO CHEMICAL COMPANY, LIMITED, Chuo-ku (JP)

(72) Inventor: Saki MATSUSHITA, Takarazuka-shi (JP)

(73) Assignee: SUMITOMO CHEMICAL COMPANY, LIMITED, Chuo-ku (JP)

(21) Appl. No.: 18/255,343

(22) PCT Filed: Nov. 30, 2021
(86) PCT No.: PCT/JP2021/043745

§ 371 Date: May 31, 2023

(30) Foreign Application Priority Data
Dec. 1, 2020 (JP) 2020-199847

(51) Int. Cl. A01N 43/54; A01N 25/30; A01N 25/04

(52) U.S. Cl. CPC A01N 43/54; A01N 25/30; A01N 25/04

(57) ABSTRACT

Provided is a pesticidal composition comprising a compound represented by the formula (I), an organic solvent having a water solubility at 25° C. of 10 mass % or less, a surfactant and water, wherein the pesticidal composition contains an aqueous phase and particles of an oil phase dispersed in the aqueous phase, the oil phase contains the organic solvent and the compound represented by the formula (I) dissolved or suspended in the organic solvent, and a volume median diameter of the particles is 0.10 μm or larger and 11 μm or smaller.

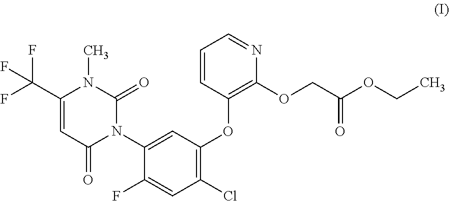 [SMILES: CCOC(=O)COc1ncccc1Oc1cc(-n2c(=O)cc(C(F)(F)F)n(C)c2=O)c(F)cc1Cl]

### TECHNICAL FIELD

The present invention relates to a pesticidal composition.

### BACKGROUND ART

A compound represented by the following formula (I), which is an active ingredient for herbicides, is known as a pesticidal active compound (see, e.g., U.S. Pat. No. 6,537,948 (Patent Literature 1)).

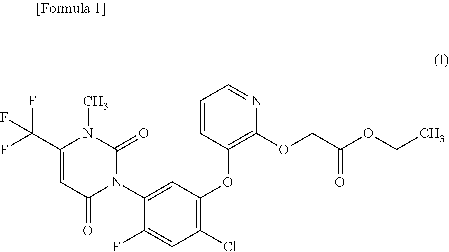 [SMILES: CCOC(=O)COc1ncccc1Oc1cc(-n2c(=O)cc(C(F)(F)F)n(C)c2=O)c(F)cc1Cl]

### CITATION LIST

### Patent Literature

PTL 1: U.S. Pat. No. 6,537,948

### SUMMARY OF INVENTION

### Technical Problem

An object of the present invention is to provide a liquid pesticidal composition comprising a compound represented by the formula (I), wherein time-dependent change in physical property is prevented.

### Solution to Problem

The present invention provides the following pesticidal composition.

[1] A pesticidal composition comprising a compound represented by the formula (I), an organic solvent having a water solubility at 25° C. of 10 mass % or less, a surfactant and water, wherein
the pesticidal composition contains an aqueous phase and particles of an oil phase dispersed in the aqueous phase,
the oil phase contains the organic solvent and the compound represented by the formula (I) dissolved or suspended in the organic solvent, and
a volume median diameter of the particles is 0.10 μm or larger and 11 μm or smaller:

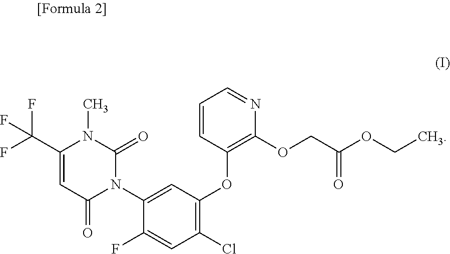 [SMILES: CCOC(=O)COc1ncccc1Oc1cc(-n2c(=O)cc(C(F)(F)F)n(C)c2=O)c(F)cc1Cl]

[2] The pesticidal composition according to [1], wherein the volume median diameter of the particles is 0.15 μm or larger and 9 μm or smaller.

[3] The pesticidal composition according to [1] or [2], wherein the organic solvent comprises an aromatic hydrocarbon.

[4] The pesticidal composition according to any of [1] to [3], wherein the surfactant comprises a nonionic surfactant.

### Advantageous Effects of Invention

It is made possible to provide a liquid pesticidal composition comprising a compound represented by the formula (I), wherein time-dependent change in physical property is prevented.

### DESCRIPTION OF EMBODIMENTS

A pesticidal composition according to the present invention (hereinafter, also simply called “pesticidal composition”) contains a compound represented by the formula (I) (hereinafter, also called “compound (I)”), an organic solvent having a water solubility at 25° C. of 10 mass % or less, a surfactant and water. The pesticidal composition is an oil-in-water emulsion containing an aqueous phase and particles of an oil phase dispersed in the aqueous phase. The oil phase contains the organic solvent and the compound (I) dissolved or suspended in the organic solvent.

In the following, a detailed description will be given of ingredients that the pesticidal composition contains or may contain.

[1] Pesticidal Active Compound

The pesticidal composition contains a compound (I) as a pesticidal active compound. In the pesticidal composition, the compound (I) is contained in the oil phase and dissolved or suspended in the organic solvent constituting the oil phase.

The pesticidal composition may contain one or more pesticidal active compounds other than the compound (I). In this case, the pesticidal active compound(s) other than the compound (I) may be dissolved or suspended in the organic solvent constituting the oil phase or may be dissolved or suspended in the aqueous phase. The pesticidal composition may contain only the compound (I) as a pesticidal active compound.

Examples of the pesticidal active compound other than the compound (I) include, but are not particularly limited to, insecticidal active ingredients, fungicidal active ingredients and herbicidal active ingredients. The pesticidal composition can contain one or more pesticidal active ingredients selected from the group consisting of insecticidal active ingredients, fungicidal active ingredients and herbicidal active ingredients as the pesticidal active compound other than the compound (I). Each of the insecticidal active ingredient, the fungicidal active ingredient and the herbicidal active ingredient may comprise one, two, or more ingredients.

With the total amount of the pesticidal active compound contained in the pesticidal composition being taken as 100 mass %, the content of the compound (I) in all the pesticidal active compounds contained in the pesticidal composition may be, for example, 0.01 mass % or more and 100 mass % or less. The content is, for example, 3 mass % or more and 100 mass % or less, 5 mass % or more and 100 mass % or less, 10 mass % or more and 100 mass % or less, 20 mass % or more and 100 mass % or less, 30 mass % or more and 100 mass % or less or 40 mass % or more and 100 mass % or less.

With the total amount of the pesticidal composition being taken as 100 mass %, the content of the compound (I) in the pesticidal composition is preferably 0.01 mass % or more and 25 mass % or less, more preferably 0.05 mass % or more and 20 mass % or less, further preferably 0.1 mass % or more and 15 mass % or less, yet further preferably mass % or more and 10 mass % or less, in view of moderately elevating the content and improving the stability of an emulsion (property of being able to continuously maintain a stable emulsified state) of the pesticidal composition.

[2] Organic Solvent

The pesticidal composition contains an organic solvent having a water solubility at 25° C. of 10 mass % or less and being capable of dissolving the compound (I). Hereinafter, this organic solvent is also called “organic solvent A”. When the pesticidal composition contains a pesticidal active compound other than the compound (I), the organic solvent A may dissolve the pesticidal active compound. The pesticidal composition may contain one, two, or more organic solvents A.

The water solubility at 25° C. of the organic solvent A may be, for example, 8 mass % or less, may be 5 mass % or less, may be 3 mass % or less, and may be 1 mass % or less. It is preferable that the pesticidal composition contain the organic solvent A having water solubility within the range because the stability of an emulsion and emulsion stability when diluted of the pesticidal composition are improved. The water solubility at 25° C. of the organic solvent A is usually 0 mass % or more and may be 10-5 mass % or more.

The water solubility at 25° C. herein refers to the solubility in water at a temperature of 25° C. and pH 7. For example, a water solubility at 25° C. of 10 mass % means that the solubility in 1 g of water at a temperature of 25° C. and pH 7 is 1×10⁻¹ g.

As the water solubility of the organic solvent, a value found in the database (Solubility Database) of International Union of Pure and Applied Chemistry (IUPAC) or National Institute of Standards and Technology (NIST) may be used. When a corresponding value is not found in the database, the water solubility of the organic solvent may be measured by determining the saturation solubility in water at a temperature of 25° C. and pH 7 by high-performance liquid chromatography.

Examples of the organic solvent A contained in the pesticidal composition include:
alcohols such as butanol, amyl alcohol, hexanol, heptanol, octanol, 2-ethylhexanol, cyclohexanol and benzyl alcohol;
esters such as acetic acid esters (e.g., ethyl acetate, butyl acetate, isoamyl acetate, isobornyl acetate, hexyl acetate, heptyl acetate, octyl acetate, and benzyl acetate), carbonic acid esters (e.g., diethyl carbonate and dibutyl carbonate), fatty acid esters (e.g., isopropyl myristate, methyl octanoate, methyl oleate, methyl laurate, dimethyl adipate, dibutyl adipate, didecyl adipate, tri-n-butyl citrate, di-n-butyl phthalate, methyl caprylate, methyl laurate, methyl myristate, methyl salicylate, methyl palmitate, methyl oleate, and ethyl palmitate), phthalic acid esters (e.g., dimethyl phthalate and diethyl phthalate), benzoic acid esters (e.g., methyl benzoate and ethyl benzoate), succinic acid esters (e.g., dioctyl succinate), and acetoacetic acid esters (e.g., tert-butyl acetoacetate and allyl acetoacetate);
ethers such as propylene glycol phenyl ether;
ketones such as cyclohexanone, 2-heptanone, isophorone, mesityl oxide, methyl isoamyl ketone, methyl isobutyl ketone, methylcyclohexanone, and acetophenone;
amides such as fatty acid dimethylamides (e.g., N,N-dimethyldecanamide, N,N-dimethyldodecanamide, N,N-dimethyltetradecanamide, and N,N-dimethyloctadecanamide), and alkylpyrrolidones (e.g., N-octyl-pyrrolidone, N-dodecyl-pyrrolidone, and N-decyl-pyrrolidone);
lactones such as γ-octanolactone and δ-octanolactone;
amines such as n-octylamine, oleylamine, and laurylamine;
aliphatic hydrocarbons such as decane, tridecane, tetradecane, hexadecane, octadecane, normal paraffin, isoparaffin, cycloparaffin, 1-undecene and 1-heneicosene;
aromatic hydrocarbons such as toluene, xylene, alkylbenzenes such as ethylbenzene, octadecylbenzene, dialkylbenzene and trialkylbenzene, alkylnaphthalenes such as methylnaphthalene, dimethylnaphthalene, dodecylnaphthalene and tridecylnaphthalene, and phenylxylylethane and 1-phenyl-1-ethylphenylethane, and a mixture of these;
fatty acids such as oleic acid, capric acid, and enanthic acid;
animal- or vegetable-derived oils such as coconut oil, olive oil, soybean oil, rape oil, castor oil, linseed oil, cottonseed oil, palm oil, avocado oil, shark liver oil, sardine oil, and saury oil;
mineral oils such as naphtha, petroleum ether, kerosene, diesel oil, paraffin, olefin, and machine oil; and
silicone oil.

As the organic solvent A, a commercially available solvent may be used. Examples of the commercially available product include, in trade names, Agnique AMD810 (mixture of N,N-dimethyloctanamide and N,N-dimethyldecanamide, manufactured by BASF), Agnique AMD10 (N,N-dimethyldecanamide, manufactured by BASF), Agnique AMD12 (N,N-dimethyldodecanamide, manufactured by BASF), Rhodiasolv ADMA810 (mixture of N,N-dimethyloctanamide and N,N-dimethyldecanamide, manufactured by Solvay Nicca), Rhodiasolv ADMA-10 (N,N-dimethyldecanamide, manufactured by Solvay Nicca), Hallcomid M-8-10 (mixture of N,N-dimethyloctanamide and N,N-dimethyldecanamide, manufactured by Stepan), Hallcomid M-10 (N,N-dimethyldecanamide, manufactured by Stepan), Hallcomid M-12 (N,N-dimethyldodecanamide, manufactured by Stepan), Hallcomid M-18 (N,N-dimethyloctadecanamide, manufactured by Stepan), Hallcomid 1025 (N,N-dimethyl-9-deceneamide, manufactured by Stepan), Genagen 4166 (fatty acid dimethylamide, manufactured by Clariant), Genagen 4296 (fatty acid dimethylamide, manufactured by Clariant), Rhodiasolv Iris (mixture of dimethyl 2-methylglutarate, dimethyl 2-ethylsuccinate, and dimethyl adipate, manufactured by Solvay), PURASOLV EHL (2-ethylhexyl-L-lactate, manufactured by Corbion purac), AGSOLEX 8 (N-octyl-pyrrolidone, manufactured by Ashland), AGSOLEX 12 (N-dodecyl-pyrrolidone, manufactured by Ashland), Stepan C-25 (methyl caprylate, manufactured by Stepan), Stepan C-42 (mixture of methyl laurate and methyl myristate, manufactured by Stepan), Stepan C-65 (mixture of methyl palmitate and methyl oleate, manufactured by Stepan), Dowanol PPh (propylene glycol phenyl ether, manufactured by Dow Chemical), Nisseki Hisol SAS-296 (mixture of 1-phenyl-1-xylylethane and 1-phenyl-1-ethylphenylethane, manufactured by JX Nippon Oil & Energy), SOLVESSO 100 (containing C9-C10 dialkyl- and trialkylbenzene as its main aromatic hydrocarbon, manufactured by ExxonMobil Chemical), SOLVESSO 150 (containing C10-C11 alkyl benzene as its main aromatic hydrocarbon, manufactured by ExxonMobil Chemical), SOLVESSO 150ND (containing C10-C11 alkyl benzene as its main aromatic hydrocarbon, manufactured by ExxonMobil Chemical), SOLVESSO 200 (containing C10-C13 alkyl naphthalene as its main aromatic hydrocarbon, manufactured by ExxonMobil Chemical), and SOLVESSO 200ND (containing C10-C13 alkyl naphthalene as its main aromatic hydrocarbon, manufactured by ExxonMobil Chemical).

In view of the solubility of the compound (I) and the stability of an emulsion and emulsion stability when diluted of the pesticidal composition, the organic solvent A preferably comprises one or more selected from the group consisting of aromatic hydrocarbons, aliphatic hydrocarbons, ketones, esters, ethers, amides, amines, and alcohols, and more preferably comprises an aromatic hydrocarbon. The aromatic hydrocarbon preferably comprises one or more selected from the group consisting of alkylbenzenes (e.g., toluene, xylene, ethylbenzene, octadecylbenzene, dialkylbenzene and trialkylbenzene), alkylnaphthalenes (e.g., methylnaphthalene, dimethylnaphthalene, dodecylnaphthalene and tridecylnaphthalene), and phenylxylylethane and 1-phenyl-1-ethylphenylethane, more preferably comprises one or more selected from the group consisting of alkylbenzenes and alkylnaphthalenes, and further preferably comprises one or more selected from the group consisting of C9-C12 alkylbenzenes and C10-C15 alkylnaphthalenes. The organic solvent A may consist of an aromatic hydrocarbon.

With the total amount of the pesticidal composition being taken as 100 mass %, the content of the organic solvent A in the pesticidal composition is preferably 0.1 mass % or more and 45 mass % or less, more preferably 0.5 mass % or more and 40 mass % or less, further preferably 1 mass % or more and 35 mass % or less, yet further preferably 3 mass % or more and 30 mass % or less. It is preferable that the pesticidal composition contain the organic solvent A at a content within the range in view of moderately elevating the content of the compound (I) and improving the stability of an emulsion, emulsion stability when diluted and miscibility with a tank-mix partner of the pesticidal composition. The tank-mix partner is, for example, an adjuvant mentioned later, and can be mixed with the pesticidal composition by a method mentioned later.

The content of the organic solvent A relative to the content of the pesticidal active compound (compound (I)) is usually 2 times by mass or more and 35 times by mass or less, preferably 2.5 times by mass or more and 30 times by mass or less, more preferably 3 times by mass or more and 25 times by mass or less, further preferably 4 times by mass or more and 20 times by mass or less, particularly preferably 5 times by mass or more and 15 times by mass or less. In view of moderately elevating the content of the compound (I) and improving the stability of an emulsion, emulsion stability when diluted and miscibility with a tank-mix partner of the pesticidal composition, it is preferable that the ratio (mass ratio) of the content of the organic solvent A to the content of the pesticidal active compound (compound (1)) be adjusted to within the range.

When the pesticidal composition contains two or more organic solvents A, the content of the organic solvent A mentioned above is the total content of the two or more organic solvents A. The same holds true for other ingredients that the pesticidal composition contains or may contain, and the content of each ingredient is the total content of two or more ingredients, if contained, unless otherwise specified. The pesticidal composition can contain an organic solvent other than the organic solvent A. However, for improving the stability of an emulsion of the pesticidal composition, it is preferable that the organic solvent contained in the pesticidal composition consist of the organic solvent A.

[3] Surfactant

The pesticidal composition contains one, two, or more surfactants. Examples of the surfactant include nonionic surfactants, anionic surfactants, cationic surfactants, and amphoteric surfactants. The pesticidal composition can contain one, two, or more surfactants selected from the group consisting of nonionic surfactants, anionic surfactants, cationic surfactants, and amphoteric surfactants.

Examples of the nonionic surfactant include:
block polymers such as polyoxyethylene polyoxypropylene block copolymers, and block polymers of alkanol, polyethylene oxide, and polypropylene oxide;
synthetic polymers such as vinyl acetate copolymers, polymethacrylic acid, and copolymers of methacrylic acid and methacrylic acid ester;
polyoxyalkylene fatty acid esters such as polyoxyethylene fatty acid esters (e.g., polyoxyethylene stearic acid ester), polyoxypropylene fatty acid esters (e.g., polyoxypropylene stearic acid ester) and polyoxyethylene polyoxypropylene fatty acid ester;
fatty acid esters such as fatty acid esters of polyol, monoglyceride, and phospholipids;
alcohol ethoxylates such as aliphatic alcohol ethoxylates (e.g., tridecyl alcohol ethoxylate, isooctyl alcohol ethoxylate, lauryl alcohol ethoxylate, hexadecyl alcohol ethoxylate, and stearyl alcohol ethoxylate), alkylphenol ethoxylates (e.g., nonylphenol ethoxylate, tristyrylphenol ethoxylate, tributylphenol ethoxylate, and octylphenol ethoxylate), arylalkylphenol ethoxylates, and arylphenol ethoxylates (e.g., monobenzylbiphenol alcohol ethoxylate);
alcohol propoxylates such as aliphatic alcohol propoxylate, alkylphenol propoxylate, and arylalkylphenol propoxylate;
polyoxyalkylene vegetable oils such as polyoxyethylene castor oil and polyoxyethylene polyoxypropylene castor oil;
polyoxyalkylene hydrogenated vegetable oils such as polyoxyethylene hydrogenated castor oil;
glycerin fatty acid esters;
glucose esters;
cellulose esters;
sucrose fatty acid esters (e.g., sucrose stearic acid diester);
polyvinyl alcohol;
sorbitan fatty acid esters such as sorbitan laurate, sorbitan stearate, sorbitan oleate and sorbitan trioleate;
polyoxyalkylene sorbitan fatty acid esters such as polyoxyethylene sorbitan laurate, polyoxyethylene sorbitan stearate, polyoxyethylene sorbitan oleate, and polyoxyethylene sorbitan trioleate;
fatty acid amine esters such as polyoxyethylene fatty acid amine ester and polyoxypropylene fatty acid amine ester;
polyoxyethylene rosin esters;
amides such as fatty acid alkanolamides (e.g., lauric acid diethanolamide), alkoxylated propylene oxide fatty acid glucamide, polyoxyethylene oleic acid amide, polyoxyethylene stearic acid amide, and polyvinylpyrrolidone; and amines such as alkoxylated amines (e.g., polyoxyethylene oleylamine, and α,α′-[(9-octadecenylimino)di-2,1-ethanediyl]bis(co-hydroxy)poly(oxyethylene)).

Examples of the anionic surfactant include:
sulfonates such as alkyl sulfonates (e.g., dodecylsulfonate), alpha olefin sulfonates, alkylbenzenesulfonates (e.g., decylbenzenesulfonate, dodecylbenzenesulfonate, tridecylbenzenesulfonate, and diphenylsulfonate), alkylnaphthalenesulfonates (e.g., naphthalenesulfonate, dibutylnaphthalenesulfonate, 2,2′-dinaphthylmethane-6,6′-disulfonate, diisopropylnaphthalenesulfonate, and triisopropylnaphthalenesulfonate), dialkylsulfosuccinates (e.g., sodium di(2-ethylhexyl)sulfosuccinate), N-methyl-N-acyltaurine salts (e.g., methyl oleoyl taurate), other lignin sulfonates, alkylphenolsulfonates and derivatives thereof, naphthalenesulfonate-formaldehyde condensates and derivatives thereof, and benzimidazolesulfonate derivatives;
sulfuric acid ester salts such as alkyl sulfates (e.g., n-hexyl sulfate, n-heptyl sulfate, lauryl sulfate, lauryl sulfuric acid di ethanol salt, and octadecyl sulfate), polyoxyethylene alkyl ether sulfates (e.g., laureth-3-sulfate), polyoxypropylene alkyl ether sulfates, and polyoxyethylene distyryl phenyl ether sulfuric acid ester salts;
carboxylates such as fatty acid salts such as octanoate, decanoate, laurate, myristate, palmitate, stearate, behenate, and oleate, and derivatives thereof, ether carboxylates such as laureth-3-carboxylate, and derivatives thereof, N-acylsarcosine salts such as N-lauroylsarcosine salt, and derivatives thereof, N-acylglutamates such as N-lauroylglutamate, and derivatives thereof, polyacrylates, polyvinyl acetates, and polycarboxylates such as comb-shaped polymers of polyacid salts, and derivatives thereof; and
phosphoric acid ester salts such as alkyl phosphates such as lauryl phosphate, and derivatives thereof, polyoxyethylene alkyl ether phosphates and derivatives thereof, polyoxyethylene alkyl phenyl ether phosphates and derivatives thereof, and polyoxypropylene alkyl ether phosphates and derivatives thereof.

Examples of the salt in the sulfonates, the sulfuric acid ester salts, the carboxylates, and the phosphoric acid ester salts include sodium salts, potassium salts, calcium salts, ammonium salts, isopropylamine salts, and triethanolamine salts.

Examples of the cationic surfactant include:
alkylamine salts such as monomethylamine salts, dimethylamine salts, trimethylamine salts, and dodecylamine salts;
fatty acid amide amine salts such as stearamide propyldimethylamine and behenamide propyldimethylamine;
polyamine salts such as polyvinylamine and polyethyleneimine; and
alkyl quaternary ammonium salts such as lauryltrimethylammonium salt, cetyltrimethylammonium salt, dodecyltrimethylammonium salts, stearylmethylammonium salts, ethylammonium benzylbis(2-chloroethyl)bromide salts, alkyldimethylbenzylammonium salts, alkylpyridinium salts, alkylisoquinolinium salts and dialkylmorpholinium salts;
benzethonium chloride; and
polyalkylvinylpyridinium salt.

Examples of the amphoteric surfactant include
N-laurylalanine, N,N,N-trimethylaminopropionic acid, N,N,N-trihydroxyethylaminopropionic acid, N-hexyl-N,N-dimethylaminoacetic acid, betaine, alkyl betaines (e.g., 1-(2-carboxyethyl)pyrimidinium betaine), imidazoline, taurine, alkyltaurine and lecithin.

As the surfactant, a commercially available surfactant may be used.

Examples of a commercially available nonionic surfactant include, in trade names, Selvol 523 (polyvinyl alcohol, manufactured by Sekisui Speciality Chemicals), Stepflow 26F (polyoxyethylene polyoxypropylene block copolymer, manufactured by Stepan), Toximul 8323 (polyoxyethylene polyoxypropylene block copolymer, manufactured by Stepan), Atlas G5000 (butyl block copolymer, manufactured by Croda), Atlas G5002L (butyl block copolymer, manufactured by Croda), Antarox B/848 (polyoxyethylene polyoxypropylene block copolymer, manufactured by Solvay), Pegnol 24-O (polyoxyethylene fatty acid ester, manufactured by TOHO Chemical Industry), Pegnol 14-S (polyoxyethylene fatty acid ester, manufactured by TOHO Chemical Industry), Pegnol ST-7 (polyoxyethylene alkyl ether, manufactured by TOHO Chemical Industry), ATPLUS245 (polyoxyethylene polyoxypropylene alkyl ether, manufactured by Croda), Synperonic AB6 (polyoxyalkylene alkyl ether, HLB: 12, manufactured by Croda), Brij O3 (polyoxyethylene oleyl ether, HLB: 7, manufactured by Croda), Genapol X060 (polyoxyethylene alkyl ether, manufactured by Clariant), Genapol X150 (polyoxyethylene alkyl ether, manufactured by Clariant), Emulsogen TS200 (polyoxyethylene tristyryl phenyl ether, manufactured by Clariant), Emulsogen TS290 (polyoxyethylene tristyryl phenyl ether, manufactured by Clariant), Emulsogen TS540 (polyoxyethylene tristyryl phenyl ether, manufactured by Clariant), Emulsogen TS600 (polyoxyethylene tristyryl phenyl ether, manufactured by Clariant), Emulsogen EL360 (polyoxyethylene castor oil, manufactured by Clariant), Emulsogen EL400 (polyoxyethylene castor oil, manufactured by Clariant), Emulsogen EL540 (polyoxyethylene castor oil, manufactured by Clariant), Solpol T26 (polyoxyethylene alkyl aryl ether, manufactured by TOHO Chemical Industry), Alkamuls OR/40 (polyoxyethylene castor oil, manufactured by Solvay), Toximul 8240 (polyoxyethylene castor oil, molar number of added EO: 36, manufactured by Stepan), Toximul 8241 (polyoxyethylene castor oil, molar number of added EO: 30, manufactured by Stepan), Toximul 8242 (polyoxyethylene castor oil, molar number of added EO: 40, manufactured by Stepan), NIKKOL HCO-20 (polyoxyethylene hydrogenated castor oil, manufactured by Nikko Chemicals), Geronol TE/250 (mixture of polyoxyethylene castor oil and polyoxyethylene polyoxypropylene monobutyl ether, manufactured by Solvay), NIKKOL MGU (glycerol fatty acid ester, manufactured by Nikko Chemicals), NIKKOL DGS-80 (glycerol fatty acid ester, manufactured by Nikko Chemicals), Newcol 20 (sorbitan laurate, manufactured by Nippon Nyukazai), and Newcol 25 (polyoxyethylene sorbitan laurate, manufactured by Nippon Nyukazai).

Examples of a commercially available anionic surfactant include, in trade names, Rhodacal 70 (calcium dodecylbenzenesulfonate, branched, manufactured by Solvay), Rhodacal 70/B (calcium dodecylbenzenesulfonate, linear, manufactured by Solvay), Rhodacal LDS-25/AP (sodium dodecylbenzenesulfonate, linear, manufactured by Solvay), Calsogen 4814 (calcium dodecylbenzenesulfonate, manufactured by Clariant), Phenylsulfonat cal (calcium dodecylbenzenesulfonate, manufactured by Clariant), Geropon CYA/75 (sodium di(2-ethylhexyl) sulfosuccinate, manufactured by Solvay), and Soprophor DS S/7 (polyoxyethylene distyryl phenyl ether sulfuric acid ester ammonium salt, manufactured by Solvay).

With the total amount of the pesticidal composition being taken as 100 mass %, the content of the surfactant in the liquid pesticidal composition is preferably 0.5 mass % or more and 30 mass % or less, more preferably 0.7 mass % or more and 25 mass % or less, further preferably 0.8 mass % or more and 20 mass % or less, yet further preferably 1 mass % or more and 15 mass % or less, particularly preferably 1.5 mass % or more and 15 mass % or less, in view of improving the stability of an emulsion, emulsion stability when diluted and miscibility with a tank-mix partner of the pesticidal composition.

The content of the surfactant relative to the content of the pesticidal active compound is preferably 0.05 times by mass or more and 30 times by mass or less, more preferably 0.07 times by mass or more and 25 times by mass or less, further preferably times by mass or more and 20 times by mass or less, particularly preferably 0.1 times by mass or more and 15 times by mass or less.

[4] Water

The pesticidal composition contains water. Examples of the water include ion-exchange water, tap water and groundwater. The water constitutes the aqueous phase of the pesticidal composition.

With the total amount of the pesticidal composition being taken as 100 mass %, the content of the water in the pesticidal composition is preferably 30 mass % or more and 95 mass % or less, more preferably 35 mass % or more and 93 mass % or less, further preferably 40 mass % or more and 90 mass % or less, yet further preferably 45 mass % or more and 87 mass % or less. In view of improving the stability of an emulsion, emulsion stability when diluted and miscibility with a tank-mix partner of the pesticidal composition, it is preferable that the pesticidal composition contain the water at a content within the range.

[5] Other Ingredients

The pesticidal composition may contain a formulation aid. Examples of other formulation aids include thickeners, antifoaming agents, antifreezing agents, and antiseptics.

Examples of the thickener include polysaccharides such as xanthan gum, clay, and silicates. With the total amount of the pesticidal composition being taken as 100 mass %, the content of the thickener in the pesticidal composition is usually 0.00 mass % or more and may be 0.05 mass % or more, and is usually 5 mass % or less and may be 3 mass % or less.

Examples of the antifoaming agent include silicone-based antifoaming agents. With the total amount of the pesticidal composition being taken as 100 mass %, the content of the antifoaming agent in the pesticidal composition is usually 0.01 mass % or more and may be 0.05 mass % or more, and is usually 1 mass % or less and may be 0.5 mass % or less.

Examples of the antifreezing agent include ethylene glycol, propylene glycol, urea, and glycerin. With the total amount of the pesticidal composition being taken as 100 mass %, the content of the antifreezing agent in the pesticidal composition is usually 1 mass % or more and may be 2 mass % or more, and is usually 10 mass % or less and may be 8 mass % or less.

Examples of the antiseptic include isothiazolinone-based antiseptics. With the total amount of the pesticidal composition being taken as 100 mass %, the content of the antiseptic in the pesticidal composition is usually 0.05 mass % or more and may be 0.1 mass % or more, and is usually 0.5 mass % or less and may be 0.3 mass % or less.

[6] Volume Median Diameter of Oil Phase Particle

The pesticidal composition is an oil-in-water emulsion containing an aqueous phase and oil phase particles dispersed in the aqueous phase. In the pesticidal composition, the volume median diameter of the oil phase particles is 0.10 μm or larger and 11 μm or smaller, preferably 0.11 μm or larger and 10 μm or smaller, more preferably 0.12 μm or larger and 9.5 μm or smaller, further preferably 0.15 μm or larger and 9 μm or smaller. The volume median diameter of the oil phase particles falls within the range, whereby a pesticidal composition for which time-dependent change in physical property is prevented can be provided. The pesticidal composition has the volume median diameter within the range of the oil phase particles immediately after preparation.

One example of the time-dependent change in physical property is time-dependent change in the volume median diameter of the oil phase particles. The time-dependent change in the volume median diameter of the oil phase particles may be time-dependent change in the volume median diameter of the oil phase particles at low temperatures (e.g., −20° C.). According to the present invention, it is possible to prevent time-dependent change in the volume median diameter of the oil phase particles at low temperatures.

The volume median diameter refers to a particle diameter at which a cumulative frequency becomes 50% in a particle size distribution. The volume particle size of the oil phase particles can be measured by a method mentioned later using a particle diameter measurement apparatus based on a laser diffraction method or a dynamic light scattering method as measurement principles. Herein, a volume median diameter of 0.4 μm or larger is a value measured by the laser diffraction method, and less than 0.4 μm is a value measured by the dynamic light scattering method. As a commercially available particle diameter measurement apparatus based on a laser diffraction method as measurement principles, Mastersizer 3000 (manufactured by Malvern Panalytical) can be used, and as a particle diameter measurement apparatus based on a dynamic light scattering method as measurement principles, Zetasizer nano zsp (manufactured by Malvern Panalytical) can be used.

The pesticidal composition can be prepared by a method comprising mixing a solution of the compound (I) containing the compound (I) which is a pesticidal active compound and the organic solvent A with water in the presence of the surfactant to obtain an emulsified liquid. For example, it is possible to adjust the volume median diameter of the oil phase particles by adjusting mixing conditions (stirring speed, etc.) in mixing the solution of the compound (I) with water.

[7] Method for Producing Pesticidal Composition

The pesticidal composition can be suitably used as a liquid pesticidal formulation called emulsion oil in water (EW) in the pesticidal field.

The pesticidal composition can be used in crop lands such as dry fields, orchard fields, pastures, lawn fields, and forestry fields; and non-crop lands such as levee slopes, riverbeds, shoulders and slopes of the roads, railroads, parks and green spaces, playgrounds, automobile parks, airports, and industrial plant sites such as factories and storage facilities as well as idle fields and urban deserts, thereby controlling weeds.

Users prepare an emulsified liquid by usually mixing the pesticidal composition with water, and applies the emulsified liquid from a knapsack sprayer, a spray tank, a spray plane, or an irrigation system. The amount of spray differs depending on climate conditions, the timing of treatment, soil conditions, target crops, target weeds, etc. and is usually 10 L or more and 2000 L or less, preferably 50 L or more and 400 L or less, per hectare. Also, the emulsified liquid is prepared by mixing the pesticidal composition with water in usually from 2 to 10000 times, preferably from 10 to 8000 times, more preferably from 15 to 6000 times the volume of the emulsified liquid.

In applying the emulsified liquid, it may be mixed with an adjuvant. Although the type of the adjuvant is not particularly limited, it is desirable to mix an oil-based adjuvant (methylated seed oil in which a mineral oil such as a paraffinic hydrocarbon, a naphthenic hydrocarbon, or an aromatic hydrocarbon, or a vegetable oil (soybean oil or rapeseed oil) is esterified) such as Agri-Dex or MSO at 0.25%, 0.5%, 1%, 2%, 3%, 4%, 5% or 6% (volume/volume) into the spray liquid, or a nonionic adjuvant (polyoxyalkylene alkyl ether, polyoxyalkylene fatty acid ester, alkylaryl alkoxylate, or alkylaryl polyoxyalkylene glycol) such as Induce at 0.05%, 0.1%, 0.25%, or 0.5% (volume/volume) into the spray liquid. Other examples thereof include anionic series (substituted sulfonates) such as Gramin S, cationic series (polyoxyethyleneamine) such as Genamin T 200BM, and organic silicone series such as Silwet L77. Furthermore, a drift control agent such as Intact (polyethylene glycol) may be mixed. The pH or hardness of the above spray liquid is not particularly limited.

### EXAMPLES

In the following, the present invention will be described in further detail with reference to Examples and Comparative Examples, etc. The scope of the present invention is not limited to these Examples.

The products used in the preparation of pesticidal compositions will be given below.

[1] Solvesso 200ND: Containing C10-C13 alkylnaphthalene as its main aromatic hydrocarbon, manufactured by ExxonMobil Chemical

[2] Toximul 8242: Polyoxyethylene castor oil, molar number of added EO: 40, manufactured by Stepan

[3] Selvol 523: Polyvinyl alcohol, manufactured by Sekisui Speciality Chemicals (an aqueous solution of 9 mass % of the surfactant was used for the preparation of the pesticidal composition)

[4] Propylene glycol: manufactured by ADEKA

[5] Stepflow 26F: Polyoxyethylene polyoxypropylene block copolymer, manufactured by Stepan

[6] Emulsogen TS200: Polyoxyethylene tristyryl phenyl ether, molar number of added EO: 20, manufactured by Clariant

### Production Example 1

0.536 parts by mass of the compound (1) active substance (purity: 98 mass %) and 4.000 parts by mass of Toximul 8242 were dissolved in 5.250 parts by mass of Solvesso 200ND to obtain a solution of the compound (I). The solution was added to 14.678 parts by mass of water and emulsified at 10000 rpm for 13 minutes using Polytron homogenizer (manufactured by KINEMATICA) and a shaft (PT-DA 3020/2) in a 50 mL volume plastic cup to obtain an emulsified liquid. The emulsified liquid, 5.000 parts by mass of Propylene glycol, 63.980 parts by mass of water, 1.000 part by mass of Toximul 8242, and 5.556 parts by mass of Selvol 523 (9 mass % aqueous solution) were mixed and stirred to obtain a pesticidal composition 1 consisting of the ingredients specified in Table 1.

The units of the values of each ingredient specified in Table 1 are mass % with the total amount of the pesticidal composition being taken as 100 mass %.

### Production Example 2

parts by mass of the compound (I) active substance (purity: 98 mass %) and 2.500 parts by mass of Toximul 8242 were dissolved in 5.250 parts by mass of Solvesso 200ND to obtain a solution of the compound (I). The solution was added to 12.428 parts by mass of water and emulsified at 3000 rpm for 10 seconds using Polytron homogenizer (manufactured by KINEMATICA) and a shaft (PT-DA 3020/2) in a 50 mL volume plastic cup to obtain an emulsified liquid. The emulsified liquid, 5.000 parts by mass of Propylene glycol, 66.230 parts by mass of water, 2.500 parts by mass of Toximul 8242, and 5.556 parts by mass of Selvol 523 (9 mass % aqueous solution) were mixed and stirred to obtain a pesticidal composition 2 consisting of the ingredients specified in Table 1.

### Production Example 3

0.536 parts by mass of the compound (I) active substance (purity: 98 mass %) were dissolved in 5.250 parts by mass of Solvesso 200ND to obtain a solution of the compound (I). 2.500 parts by mass of Stepflow 26F were dissolved in 26.428 parts by mass of water to obtain an aqueous solution of the surfactant. The solution of the compound (I) was added to the aqueous solution of the surfactant and emulsified at 3000 rpm for 10 seconds and at 5000 rpm for 1 minute using Polytron homogenizer (manufactured by KINEMATTCA) and a shaft (PT-DA 3020/2) in a 50 mL volume plastic cup to obtain an emulsified liquid. The emulsified liquid, 5.000 parts by mass of Propylene glycol, 57.786 parts by mass of water, and 2.500 parts by mass of Stepflow 26F were mixed and stirred to obtain a pesticidal composition 6 consisting of the ingredients specified in Table 1.

### Production Example 4

0.536 parts by mass of the compound (I) active substance (purity: 98 mass %) were dissolved in 5.250 parts by mass of Solvesso 200ND to obtain a solution of the compound (1). 2.500 parts by mass of Emulsogen TS200 were dissolved in 26.428 parts by mass of water to obtain an aqueous solution of the surfactant. The solution of the compound (I) was added to the aqueous solution of the surfactant and emulsified at 3000 rpm for 10 seconds and at 5000 rpm for 1 minute using Polytron homogenizer (manufactured by KINEMATICA) and a shaft (PT-DA 3020/2) in a 50 mL volume plastic cup to obtain an emulsified liquid. The emulsified liquid, 5.000 parts by mass of Propylene glycol, 57.786 parts by mass of water, and 2.500 parts by mass of Emulsogen TS200 were mixed and stirred to obtain a pesticidal composition 8 consisting of the ingredients specified in Table 1.

### Comparative Production Example 1

0.536 parts by mass of the compound (I) active substance (purity: 98 mass %) and 5.000 parts by mass of Toximul 8242 were dissolved in 5.250 parts by mass of Solvesso 200ND to obtain a solution of the compound (I). The solution was added to 16.178 parts by mass of water and emulsified at 10000 rpm for 10 minutes using Polytron homogenizer (manufactured by KINEMATICA) and a shaft (PT-DA 3020/2) in a 50 mL volume plastic cup to obtain an emulsified liquid. The emulsified liquid, 5.000 parts by mass of Propylene glycol, 62.480 parts by mass of water, and 5.556 parts by mass of Selvol 523 (9 mass % aqueous solution) were mixed and stirred to obtain a pesticidal composition 3 consisting of the ingredients specified in Table 1.

### Comparative Production Example 2

0.536 parts by mass of the compound (1) active substance (purity: 98 mass %) and 2.500 parts by mass of Toximul 8242 were dissolved in 5.250 parts by mass of Solvesso 200ND to obtain a solution of the compound (I). The solution was added to 12.428 parts by mass of water and shaken by manual shaking to obtain an emulsified liquid. The emulsified liquid, 5.000 parts by mass of Propylene glycol, 66.230 parts by mass of water, 2.500 parts by mass of Toximul 8242, and 5.556 parts by mass of Selvol 523 (9 mass % aqueous solution) were mixed and stirred to obtain a pesticidal composition 4 consisting of the ingredients specified in Table 1.

### Comparative Production Example 3

0.536 parts by mass of the compound (1) active substance (purity: 98 mass %) were dissolved in 5.250 parts by mass of Solvesso 200ND to obtain a solution of the compound (I). 5.556 parts by mass of Selvol 523 (9 mass % aqueous solution) were dissolved in 6.015 parts by mass of water to obtain an aqueous solution of the surfactant. The solution of the compound (I) was added to the aqueous solution of the surfactant and emulsified at 3000 rpm for 30 seconds using Polytron homogenizer (manufactured by KINEMATICA) and a shaft (PT-DA 3020/2) in a 50 mL volume plastic cup to obtain an emulsified liquid. The emulsified liquid, 5.000 parts by mass of Propylene glycol, 72.643 parts by mass of water, and 5.000 parts by mass of Toximul 8242 were mixed and stirred to obtain a pesticidal composition 5 consisting of the ingredients specified in Table 1.

### Comparative Production Example 4

0.536 parts by mass of the compound (I) active substance (purity: 98 mass %) were dissolved in 5.250 parts by mass of Solvesso 200ND to obtain a solution of the compound (I). 5.000 parts by mass of Stepflow 26F were dissolved in 23.928 parts by mass of water to obtain an aqueous solution of the surfactant. The solution of the compound (I) was added to the aqueous solution of the surfactant and emulsified at 10000 rpm for 1 minute using Polytron homogenizer (manufactured by KINEMATICA) and a shaft (PT-DA 3020/2) and at an output of 5 for 20 minutes using an ultrasonic homogenizer UD-200 (manufactured by TOMY Seiko Co., Ltd.) in a 50 mL volume plastic cup to obtain an emulsified liquid. The emulsified liquid, 5.000 parts by mass of Propylene glycol, and 60.286 parts by mass of water were mixed and stirred to obtain a pesticidal composition 7 consisting of the ingredients specified in Table 1.

### Comparative Production Example 5

0.536 parts by mass of the compound (I) active substance (purity: 98 mass %) were dissolved in 5.250 parts by mass of Solvesso 200ND to obtain a solution of the compound (I). 2.500 parts by mass of Emulsogen TS200 were dissolved in 26.428 parts by mass of water to obtain an aqueous solution of the surfactant. The solution of the compound (I) was added to the aqueous solution of the surfactant and shaken by manual shaking to obtain an emulsified liquid. The emulsified liquid, 5.000 parts by mass of Propylene glycol, 57.786 parts by mass of water, and 2.500 parts by mass of Emulsogen TS200 were mixed and stirred to obtain a pesticidal composition 9 consisting of the ingredients specified in Table 1.

### Test Example: Time-Dependent Change in Volume Median Diameter of Oil Phase Particles

A volume median diameter D1 of oil phase particles was measured as to the pesticidal composition immediately after preparation. Then, the pesticidal composition was placed in a glass vessel and stored at −20° C. Fourteen days after the storage started, a volume median diameter D2 of the oil phase particles was measured. Volume median diameters D1 and D2 were measured using Zetasizer nano zsp (manufactured by Malvern Panalytical) or Mastersizer 3000 (manufactured by Malvern Panalytical). The results are shown in Table 1.

The measurement conditions for volume median diameters D1 and D2 are as follows.

(Mastersizer 3000)

Sample
Type of particles: Non-spherical
Refractive index: 1.52
Absorptance: 0.1
Density: 1

Dispersion Medium
Water, Refractive index: 1.33

Dilution Method

Diluted with ion-exchange water into a concentration at which scattering intensity falls within 3 to 10%

Analysis
Analysis model: General-purpose

(Zetasizer Nano Zsp)

Sample
Refractive index: 1.52
Absorptance: 0.1

Dispersion Medium
Water, Viscosity: 0.8872 cP, Refractive index: 1.33

Cell
Polystyrene DTS0012

Detection Angle
Measurement angle: 173° Backscatter

Measurement Temperature
25° C. (equilibration time: 0 sec)

Dilution Method
Diluted with ion-exchange water

Measurement Time
Run duration: 10 sec, The number of runs: 10 to 12 times

On the basis of the measurement results, the rate of change in volume median diameter was determined according to the expression given below. The results are shown in Table 1.

Rate of change in volume median diameter (%)=100×D2/D1

TABLE 1

| | | | Pesticidal composition | | | | | | | | |
|---|---|---|---|---|---|---|---|---|---|---|---|
| | | | 1 | 2 | 3 | 4 | 5 | 6 | 7 | 8 | 9 |
| Pesticidal active | Compound (I) | | 0.536 | | | | | | | | |
| compound | (purity: 98%) | | | | | | | | | | |
| Organic solvent | Solvesso 200ND | | 5.250 | | | | | | | | |
| Surfactant | Toximul 8242 | | 5.000 | | | | | — | | — | |
| | Selvol 523 (9 mass % | | 5.556 | | | | | — | | — | |
| | aqueous solution) | | | | | | | | | | |
| | Stepflow 26F | | — | | | | | 5.000 | | — | |
| | Emulsogen TS200 | | — | | | | | — | | 5.000 | |
| Antifreezing | Propylene glycol | | 5.000 | | | | | | | | |
| agent | | | | | | | | | | | |
| Water | | | 78.658 | | | | | | 84.214 | | 84.214 |
| Total | | | 100 | | | | | | | | |
| Volume | D1 | Zetasizer nano | 0.155 | | 0.085 | | | | 0.087 | | |
| medium | (initial) | Mastersizer | | 8.16 | | 18.6 | 31.1 | 6.78 | | 4.44 | 11.4 |
| diameter | | 3000 | | | | | | | | | |
| (μm) | D2 | Zetasizer nano | 0.159 | | 0.127 | | | | 0.569 | | |
| | (14 days | Mastersizer | | 8.24 | | 13.6 | 22.1 | 6.85 | | 4.42 | 8.91 |
| | later) | 3000 | | | | | | | | | |

| | | | | | | | | | |
|---|---|---|---|---|---|---|---|---|---|
| Rate of change in volume median diameter (%) | 103 | 101 | 149 | 73 | 71 | 101 | 654 | 100 | 78 |

1. A pesticidal composition comprising a compound represented by the formula (I), an organic solvent having a water solubility at 25° C. of 10 mass % or less, a surfactant and water, wherein
the pesticidal composition contains an aqueous phase and particles of an oil phase dispersed in the aqueous phase,
the oil phase contains the organic solvent and the compound represented by the formula (I) dissolved or suspended in the organic solvent, and
a volume median diameter of the particles is 0.10 μm or larger and 11 μm or smaller:

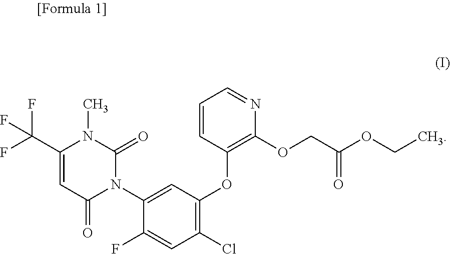 [SMILES: CCOC(=O)COc1ncccc1Oc1cc(-n2c(=O)cc(C(F)(F)F)n(C)c2=O)c(F)cc1Cl]

2. The pesticidal composition according to claim 1, wherein the volume median diameter of the particles is 0.15 μm or larger and 9 μm or smaller.

3. The pesticidal composition according to claim 1, wherein the organic solvent comprises an aromatic hydrocarbon.

4. The pesticidal composition according to claim 1, wherein the surfactant comprises a nonionic surfactant.

5. The pesticidal composition according to claim 2, wherein the organic solvent comprises an aromatic hydrocarbon.

6. The pesticidal composition according to claim 2, wherein the surfactant comprises a nonionic surfactant.

7. The pesticidal composition according to claim 3, wherein the surfactant comprises a nonionic surfactant.

8. The pesticidal composition according to claim 5, wherein the surfactant comprises a nonionic surfactant.
